(19) United States
(12) Patent Application Publication
(10) Pub. No.: US 2010/0118227 A1
(43) Pub. Date: May 13, 2010

(54) LIQUID CYSTAL DISPLAY PANEL WITH MICROLENS ARRAY AND METHOD FOR MANUFACTURING THE SAME

(76) Inventors: Satoshi Shibata, Osaka (JP); Nobuo Sasaki, Osaka (JP); Takehiro Murao, Osaka (JP); Toshiyuki Yoshimizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/593,403

(22) PCT Filed: Dec. 21, 2007
(86) PCT No.: PCT/JP2007/074635

§ 371 Date: Sep. 28, 2009

(30) Foreign Application Priority Data
Mar. 28, 2007 (JP) 2007-085835

(51) Int. Cl. G02F 1/13357; G02F 1/13; G02F 1/1333

(52) U.S. Cl. 349/58; 349/187; 349/62

(57) ABSTRACT

A highly reliable liquid crystal display panel is provided in which problems such as mixing of foreign matter are prevented.

A liquid crystal display panel according to the present invention includes: a composite substrate including a pair of substrates and a liquid crystal layer disposed between the pair of substrates; a microlens array provided on a light-incident side of the composite substrate; a support provided on the light-incident side of the composite substrate so as to surround the microlens array; and an optical film attached to the composite substrate via the support. The support has a protrusion protruding from an outer principal face of the support toward the external space. A venthole is formed in the support, the venthole connecting an internal space surrounded by the support and the external space. An opening of the venthole on the external space side is formed in the protrusion.

### TECHNICAL FIELD

The present invention relates to a liquid crystal display panel, and more particularly to a liquid crystal display panel and a liquid crystal display device which include a microlens array.

### BACKGROUND ART

In recent years, liquid crystal display devices are widely used as display devices for monitors, projectors, mobile information terminals, mobile phones, and the like. Generally speaking, a liquid crystal display device allows the transmittance (or reflectance) of a liquid crystal display panel to vary with a driving signal, thus modulating the intensity of light from a light source for irradiating the liquid crystal display panel, whereby images and text characters are displayed. Liquid crystal display devices include direct-viewing type display devices in which images or the like that are displayed on the liquid crystal display panel are directly viewed, projection-type display devices (projectors) in which images or the like that are displayed on the display panel are projected onto a screen through a projection lens in an enlarged size, and so on.

By applying a driving voltage which corresponds to an image signal to each of the pixels that are in a regular matrix arrangement, a liquid crystal display device causes a change in the optical characteristics of a liquid crystal layer in each pixel, and regulates the transmitted light in accordance with the optical characteristics of the liquid crystal layer with polarizers, phase difference elements, or the like (hereinafter referred to as optical elements) being disposed at the front and rear thereof, thereby displaying images, text characters, and the like. In the case of a direct-viewing type liquid crystal display device, films composed of such optical elements are usually directly attached to a light-entering substrate (the rear substrate) and a light-outgoing substrate (the front substrate or viewer-side substrate) of the liquid crystal display panel.

One method for applying an independent driving voltage for each pixel is an active matrix type. On a liquid crystal display panel of the active matrix type, switching elements and wiring lines for supplying driving voltages to the pixel electrodes need to be provided. As switching elements, non-linear 2-terminal devices such as MIM (metal-insulator-metal) devices and 3-terminal devices such as TFT (thin film transistor) devices are in use.

On the other hand, in a liquid crystal display device of the active matrix type, when strong light enters a switching element (in particular a TFT) which is provided on the display panel, its element resistance in an OFF state is decreased, thereby allowing the electric charge which was charged to the pixel capacitor under an applied voltage to be discharged, such that a predetermined displaying state cannot be obtained. Thus, there is a problem of light leakage even in a black state, thus resulting in a decreased contrast ratio.

Therefore, in a liquid crystal display panel of the active matrix type, in order to prevent light from entering the TFTs (in particular channel regions), a light shielding layer (called a black matrix) is provided on a TFT substrate on which the TFTs and the pixel electrodes are provided, or on a counter substrate that opposes the TFT substrate via the liquid crystal layer, for example.

However, in a liquid crystal display device which performs displaying by utilizing transmitted light, providing a light shielding layer in addition to the TFTs, gate bus lines, and source bus lines, which do not transmit light, will allow the effective pixel area to be decreased, thus resulting in a decrease in the ratio of the effective pixel area to the total area of the displaying region, i.e., the aperture ratio.

As liquid crystal display panels become higher in resolution and smaller in size, this tendency becomes more outstanding. The reason is that, even if the pixel pitch is decreased, constraints such as electrical performance and fabrication techniques make it impossible for the TFTs, the bus lines, etc., to become smaller than certain sizes.

Especially in recent years, as the display devices of mobile devices such as mobile phones, transflective-type liquid crystal display devices have become prevalent which perform display under dark lighting by utilizing light from a backlight transmitted through a liquid crystal display panel and perform display under bright lighting by reflecting light entering the display surface of the liquid crystal display panel from the surroundings. In a transflective-type liquid crystal display device, a region (reflection region) which performs display in the reflection mode and a region (transmission region) which performs display in the transmission mode are included in each pixel. Therefore, reducing the pixel pitch significantly will lower the ratio of the area of transmission region to the total area of the displaying region (aperture ratio of the transmission region). Thus, although transflective-type liquid crystal display devices have the advantage of realizing displaying with a high contrast ratio irrespective of the ambient brightness, they have a problem in that their brightness is lowered.

Accordingly, in order to improve the efficiency of light utility of a liquid crystal display device, there is a method of providing microlenses for converging light in each pixel on the liquid crystal display panel to improve the effective aperture ratio of the liquid crystal display panel. For example, it is a method of providing convex microlenses on the backlight-incident side of a composite substrate which is obtained by attaching a TFT substrate and a counter substrate together.

Patent Document 1 discloses an example of a liquid crystal display device for which this method is adopted. It discloses a method that radiates UV irradiation light through a CF substrate, which is a counter substrate, and forms microlenses in a self-aligning manner by varying the incident angle of the UV irradiation light with respect to the liquid crystal panel (self alignment method).

In a structure in which convex microlenses are provided on the backlight-incident side of a composite substrate with the convex microlenses facing toward the backlight-incident side, the composite substrate being composed of a TFT substrate and a counter substrate attached together, an optical film will be attached on the convex portions of the microlenses. When an optical film is directly attached on the convex portions of the microlenses, the attachment strength of the optical film is lowered, so that the optical film becomes likely to peel. Moreover, the adhesion layer will be buried among the lenses with the attachment of the optical film, so that an adequate lens function will not be exhibited. In order to cope with this problem, Patent Document 2 and Patent Document 3 disclose a method in which protrusions having the same height as or a greater height than that of the microlenses (hereinafter referred to as supports) are provided in the neighborhood of a microlens array of a plurality of microlenses, and an optical film is attached and affixed onto the supports by using an adhesive.

Incidentally, when manufacturing a liquid crystal display panel, the production efficiency will be poor if only one liquid crystal display panel is to be formed on one substrate. Therefore, in recent years, a method of forming a plurality of liquid crystal display panel on a single mother substrate is adopted with a view to improving the production efficiency of the liquid crystal display panel. An example of a production method of a liquid crystal display panel by such a method is disclosed in Patent Document 4. In the method disclosed in Patent Document 4, sealing members corresponding to a plurality of liquid crystal display panels are first printed on one mother substrate; after dripping liquid crystal inside each sealing member, another substrate is attached; and after an optical film is attached to the attached substrates, the substrates are cut. Thus, a plurality of liquid crystal display panels are obtained at one time.

[Patent Document 1] Japanese Laid-Open Patent Publication No. 2005-196139

[Patent Document 2] Japanese Laid-Open Patent Publication No. 2005-195733

[Patent Document 3] Japanese Laid-Open Patent Publication No. 2005-208553

[Patent Document 4] Japanese Laid-Open Patent Publication No. 2004-004636

### DISCLOSURE OF INVENTION

### Problems to be Solved by the Invention

An example of a liquid crystal display panel in which an array of convex microlenses is provided on the backlight-incident side will be described. FIG. 11 is a cross-sectional view of such a liquid crystal display panel 100, and FIG. 12 is a diagram showing the construction of the microlens array, the support, and the like when the liquid crystal display panel 100 is viewed from the backlight-incident side (lower side of FIG. 11).

As shown in FIGS. 11 and 12, the liquid crystal display panel 100 includes a composite substrate 112, a microlens array 114 consisting of a plurality of microlenses 114a disposed on the backlight-incident side of the composite substrate 112, a support 126 provided around the microlens array 114, an optical film 122 provided on the viewer's side (upper side of FIG. 11) of the composite substrate 112, and a protection layer 135 and an optical film 123 provided on the backlight-incident side of the microlens array 114.

The composite substrate 112 includes a TFT substrate 130 on which switching elements are formed for the respective pixels, a CF substrate (color filter substrate) 132 which is a counter substrate, and a liquid crystal layer 134 disposed between the TFT substrate 130 and the CF substrate 132. The liquid crystal layer 134 is sealed by a sealing member 136 having a substantially rectangular planar shape, which is provided at the display outer periphery portion between the TFT substrate 130 and the CF substrate 132. The optical film 122 is attached to the composite substrate 112 via an adhesion layer 124, and the optical film 123 is attached to the protection layer 135 via an adhesion layer 137. Moreover, a venthole 127 is provided in the support 126.

Next, a production method for the liquid crystal display panel 100 will be described.

FIGS. 13(a) to (d) are cross-sectional views showing a production method for the liquid crystal display panel 100. Herein, FIGS. 13(a) to (c) show steps by which a plurality of liquid crystal display panels 100 as shown in FIG. 11 are simultaneously formed on a single mother substrate, and FIG. 13(d) shows a step of severing the plurality of liquid crystal display panels 100 formed on the mother substrate whereby a plurality of independent liquid crystal display panels 100 are obtained. Therefore, in FIGS. 13(a) to (c), the TFT substrates 130, the CF substrates 132, the optical films 122 and 123, and the like which are constituent elements of the plurality of liquid crystal display panels 100 are each represented as a single continuous layer, as 130′, 132′, 122′, or 123′.

First, as shown in FIG. 13(a), a composite substrate 112′ is provided, which is a large mother plate having a plurality of liquid crystal layers 134 formed between a TFT substrate 130′ and a CF substrate 132′ by a liquid crystal dropping method. Each liquid crystal layer 134 is sealed by a sealing member 136, and a dummy sealing member 136′ is formed in the outer periphery portion of the composite substrate 112′.

Next, a large-sized dry film of a photocurable resin or the like (dry film resist) is attached on the outer face of the TFT substrate 130′; the dry film is subjected to exposure through a photomask; and unnecessary portions of the dry film are removed via a development treatment, whereby microlens arrays 114 and supports 126 are formed. A dummy support 126′ is formed near the outer periphery of the TFT substrate 130′, and ventholes 127 as shown in FIG. 12 are formed in the supports 126. Formation of the microlenses 114a may be performed by using a self-aligning type formation method (self alignment method) described in Patent Document 1.

Next, a large-sized dry film is attached so as to be in contact with the microlens array 114 and the support 126; it is subjected to an exposure step; and unnecessary portions of the dry film are removed via a development treatment, thereby forming protection layers 135 as shown in FIG. 13(b).

Without forming the protection layers 135, an optical film 123′ might be directly attached to the convex portions of the microlenses 114a via an adhesion layer 137′. In that case, however, bumps and dents will be formed on the adhesion layer 137′ due to external pressing, so that display unevenness may occur that is associated with the nonuniform thickness of the adhesion layer 137′. In order to handle this problem, in the liquid crystal display panel 100, the protection layer 135 is provided between the microlens array 114 and the adhesion layer 137′.

Thereafter, as shown in FIG. 13(c), a large-sized optical film 122′ is attached to the CF substrate 132′ via the adhesion layer 124′, and a large-sized optical film 123′ is attached to the protection layer 135 via an adhesion layer 137′.

After the optical film 123′ is attached, usually, an autoclave treatment is performed using a pressurizing apparatus. An autoclaving ensures that the optical film 123′ is attached under a high temperature and high pressure, whereby a strong adhesion is attained in a short time.

Moreover, air voids that are included in the adhesive or the like are removed through an autoclaving, whereby a strong adhesion is attained.

Now, assume for example that the venthole 127 is not formed in the support 126. Then, an internal space (sealed air layer) that is sealed by the microlenses 114a, the protection layer 135, and the support 126 will be formed, so that a temperature difference and a pressure difference will occur between the internal space and the exterior of the apparatus when performing the autoclaving, thus possibly causing deformation or peeling of the optical film. Such deformation or peeling not only will deteriorate the adhesive strength of the optical film, but also may cause display unevenness. Furthermore, since the internal space is sealed, dew condensation may occur in the displaying region during use of the liquid crystal display panel 100, thus possibly causing display unevenness.

In order to solve this problem, as shown in FIG. 12, a venthole 127 for connecting the internal space and the external space is provided in the support 126 of the liquid crystal display panel 100.

Finally, as shown in FIG. 13(d), the multilayer substrate is cut by using a method disclosed in Patent Document 4, for example, whereby a plurality of liquid crystal display panels 100 are completed. In the step of cutting the multilayer substrate, the cutting position is chosen so as not to be in the region where the support 126 is formed, so that the support 126 itself will not be severed.

Through the above-described production method, a plurality of liquid crystal display panels 100 can be efficiently produced. However, the production steps thereof have a problem in that, when the unnecessary portions of the dry film are removed through a development treatment in the step of forming the protection layer 135, the developer and uncured dry film may intrude into the internal space through the venthole 127, thus deteriorating the display quality of the liquid crystal display panel 100.

The present invention has been made in view of the aforementioned problems, and an objective thereof is to provide a liquid crystal display panel in which problems such as mixing of foreign matter, deformation, and peeling are not likely to occur, and which has a good display quality.

### Means for Solving the Problems

A production method for a liquid crystal display panel according to the present invention is a production method for a liquid crystal display panel having: a composite substrate including a liquid crystal layer disposed between a pair of substrates; a microlens array provided on a ligh incident side of the composite substrate; and an optical film provided on a light-incident side of the microlens array, with an internal space being formed between the microlens array and the optical film, the production method for a liquid crystal display panel comprising the steps of: (a) forming a resin layer on a face of a mother liquid crystal substrate, the mother liquid crystal substrate including a plurality of said composite substrates; (b) processing the resin layer to form a plurality of microlens arrays and a plurality of supports respectively surrounding the plurality of microlens arrays; and (c) cutting the mother liquid crystal substrate to obtain a plurality of liquid crystal display panels, wherein, at step (b), a gap which is connected to the internal space is formed in each of the plurality of supports; and at step (c), upon cutting of the mother liquid crystal substrate, an opening connecting the gap and an external space is formed in an outer face of each of the plurality of supports.

In one embodiment, at step (b), a protrusion protruding from the outer principal face toward the external space is formed on each support, a portion of the gap being formed in the protrusion.

In one embodiment, at step (c), the opening connecting the gap and the external space is formed when the protrusion is cut upon cutting of the mother liquid crystal substrate.

At step (c), the mother liquid crystal substrate and the protrusion are cut by a cutter, and an angle of approach of the cutter with respect to a side face of the protrusion is less than 90°.

In one embodiment, at step (c), an angle of approach of the cutter with respect to the side face of the protrusion is no less than 20° and no more than 80°.

In one embodiment, at step (b), a bent portion which is bent by about 90° as viewed from a plane normal direction of the composite substrate is formed on the support, and the protrusion is formed so as to protrude from the bent portion.

In one embodiment, at step (b), the gap is formed so as to extend in an oblique direction with respect to an inner face or the outer face of the support as viewed from a plane normal direction of the composite substrate.

In one embodiment, at step (b), the gap is formed in the support so as to extend while bending as viewed from a plane normal direction of the composite substrate.

A liquid crystal display panel according to the present invention comprises: a composite substrate including a pair of substrates and a liquid crystal layer disposed between the pair of substrates; a microlens array provided on a light-incident side of the composite substrate; a support provided on the light-incident side of the composite substrate so as to surround the microlens array; and an optical film attached to the composite substrate via the support, wherein, the support has a protrusion protruding from an outer principal face of the support toward an external space; a venthole is formed in the support, the venthole connecting an internal space surrounded by the support and an external space; and an opening of the venthole on the external space side is formed in the protrusion.

In one embodiment, the principal face of the support is a face which is formed substantially in parallel to a direction that the support extends, or substantially in parallel to one of side faces of the composite substrate.

In one embodiment, the protrusion has a cut facet which is formed substantially in parallel to the principal face of the support, or substantially in parallel to one of side faces of the composite substrate, and the opening of the venthole is formed in the cut facet.

In one embodiment, an angle between the cut facet and the side face of the protrusion is greater than 90°.

In one embodiment, the angle between the cut facet and the side face of the protrusion is no less than 100° and no more than 160°.

In one embodiment, the support has a bent portion which is bent by about 90° as viewed from a plane normal direction of the composite substrate, and the protrusion protrudes from the bent portion toward the external space.

In one embodiment, the venthole extends in an oblique direction with respect to an inner face or an outer face of the support as viewed from a plane normal direction of the composite substrate.

In one embodiment, the venthole extends while bending as viewed from a plane normal direction of the composite substrate.

In one embodiment, a cross section of the venthole on a plane which is perpendicular to a direction that the venthole extends has a width of no less than 50 μm and no more than 500 μm.

In one embodiment, a plurality of said ventholes are formed in different portions of the support.

### EFFECTS OF THE INVENTION

According to a production method for a liquid crystal display panel of the present invention, a venthole connecting the internal space and the external space is formed when a portion of a support is cut at the same time a mother composite substrate is cut. Therefore, after the support is formed and until the mother composite substrate is cut, no gap that connects the internal space and the external space is formed in the support. As a result, when forming a protection layer and the like between the step of forming the support and the step of cutting the mother composite substrate, a developer, resin pieces, and the like are prevented from intruding into the internal space.

Moreover, by ensuring that the angle of approach of a cutter with respect to a support or a protrusion is less than 90° in the step of cutting the support, the impact or stress received by the support or protrusion during the cutting is reduced, whereby occurrence of cracks in the support or protrusion can be alleviated.

In accordance with a liquid crystal display panel of the present invention, a venthole connecting the external space and the internal space is formed in a protrusion of the support, an opening of the venthole at the external space side being formed in the protrusion. Therefore, when producing such a liquid crystal display panel, it can be ensured that no gap that connects the internal space and the external space is formed in the support after the support is formed and before the mother composite substrate is cut. As a result, when forming a protection layer and the like between the step of forming the support and the step of cutting the mother composite substrate, a developer, resin pieces, and the like are prevented from intruding into the internal space, whereby a liquid crystal display panel with reduced problems can be obtained.

Moreover, the angle between a cut facet of the venthole on the external space side on which an opening is formed and a side face of the protrusion is greater than 90°. As a result, in the step of cutting the protrusion during the production of this liquid crystal display panel, the angle of approach of a cutter with respect to the protrusion can be made less than 90°. As a result, the impact or stress received by the protrusion during the cutting is reduced, whereby a high-quality liquid crystal display panel with reduced occurrences of cracks in the protrusion is obtained.

Thus, in accordance with the liquid crystal display panel of the present invention and the production method thereof, a liquid crystal display panel having a good display quality can be provided efficiently, in which problems such as mixing of foreign matter, deformation, and peeling are unlikely to occur.

### BRIEF DESCRIPTION OF DRAWINGS

FIG. 1 A cross-sectional view schematically showing the construction of a liquid crystal display panel according to an embodiment of the present invention.

FIG. 2 A plan view showing the construction of a microlens array, a support, and the like of a liquid crystal display panel according to an embodiment.

FIG. 3 A diagram showing the construction of a corner portion of the support in FIG. 2 in more detail.

FIG. 4 A diagram showing first to fourth steps among the production steps of a liquid crystal display panel according to the present invention.

FIG. 5 A diagram showing fifth to eighth steps among the production steps of a liquid crystal display panel according to the present invention.

FIG. 6 A diagram showing ninth and tenth steps among the production steps of a liquid crystal display panel according to the present invention.

FIG. 7 A diagram showing a severing step of a mother substrate according to the present invention, where: (a) is a plan view showing the construction of supports and their neighborhood before the mother substrate is severed; and (b) is a plan view showing the construction of a support and its neighborhood after severing.

FIG. 8 A diagram showing the construction of a corner portion of a support according to a first variant of the embodiment.

FIG. 9 A diagram showing the construction of an edge portion of a support according to a second variant of the embodiment, where: (a) shows the construction of the edge portion before the mother substrate is severed; and (b) shows the construction of the edge portion after the mother substrate is severed.

FIG. 10 A diagram showing the construction of an edge portion of a support according to a third variant of the embodiment, where: (a) shows the construction of the edge portion before the mother substrate is severed; and (b) shows the construction of the edge portion after the mother substrate is severed.

FIG. 11 A cross-sectional view showing an example of a liquid crystal display panel having a microlens array.

FIG. 12 A plan view showing the construction of a microlens array, a support, and the like of the liquid crystal display panel of FIG. 11.

FIG. 13 A diagram showing a production method of the liquid crystal display panel shown in FIG. 11.

### DESCRIPTION OF REFERENCE NUMERALS

10 liquid crystal display panel
12 composite substrate
12′ mother liquid crystal substrate
14 microlens array
14a microlens
17 internal space
18 external space
22, 22′, 23, 23′ optical film
24, 24′ adhesion layer
26 support
26′ dummy support
26a protrusion
26b principal face
26c cut facet
26d side face
27 venthole
27′ gap
27a opening
30 TFT substrate
30′ mother TFT substrate
32 CF substrate
32′ mother CF substrate
34 liquid crystal layer
35 protection layer
36 sealing member
36′ dummy sealing member
37, 37′ adhesion layer
38, 39 dry film
40, 41 photomask
50, 51 direction in which cutter is moved
100 liquid crystal display panel
112, 112′ composite substrate
114 microlens array
114a microlens
122, 123 optical film
124, 137 adhesion layer
126 support
126′ dummy support
127 venthole
130, 130′ TFT substrate
132, 132′ CF substrate
134 liquid crystal layer
135 protection layer
136 sealing member
136′ dummy sealing member

### BEST MODE FOR CARRYING OUT THE INVENTION

### Embodiment

Hereinafter, with reference to the drawings, an embodiment of a liquid crystal display panel according to the present invention will be described.

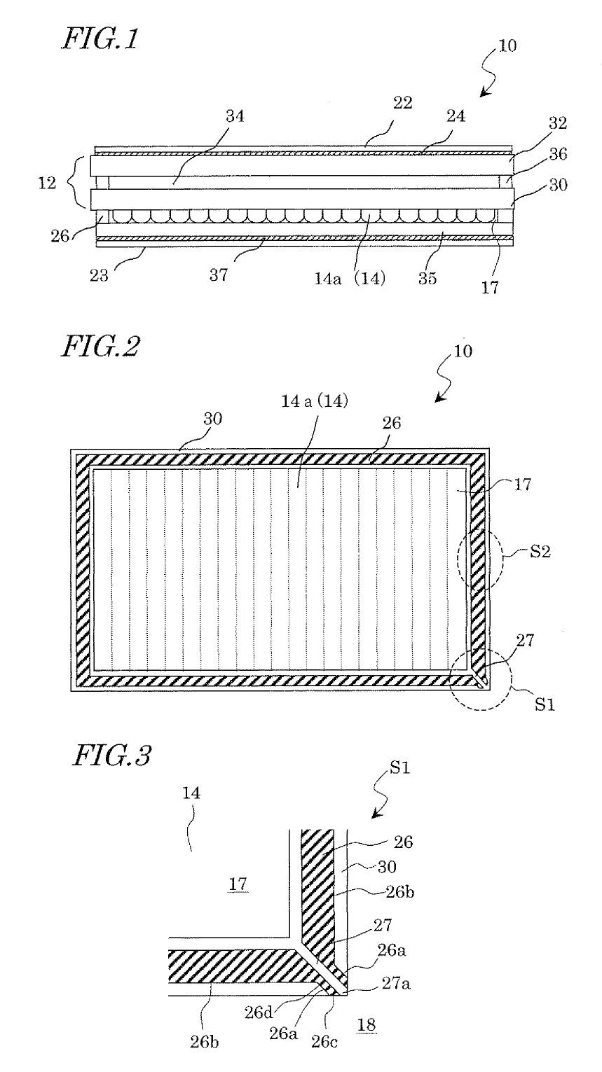

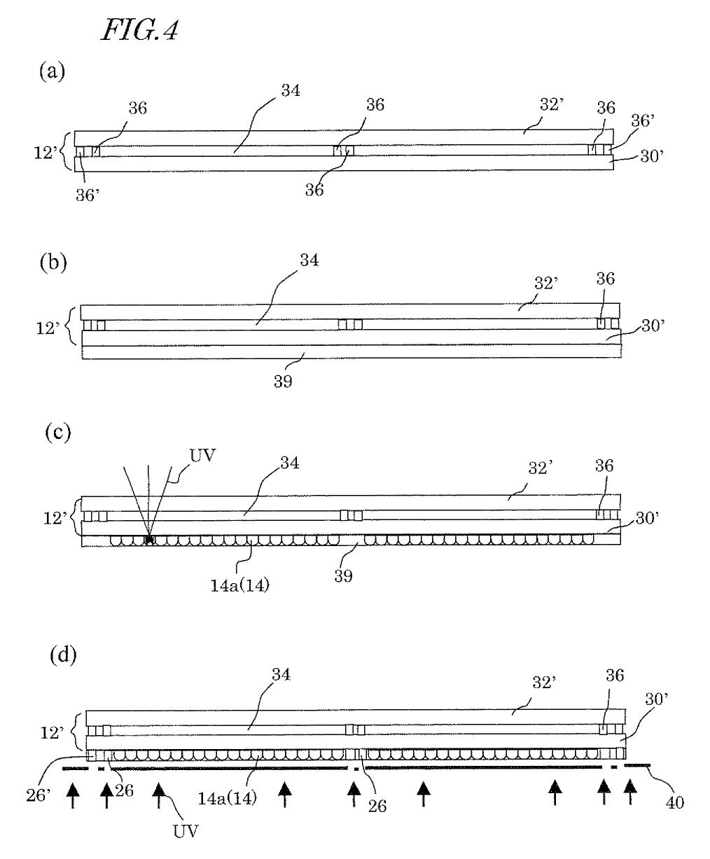

FIG. 1 is a cross-sectional view of a liquid crystal display panel 10 of the present embodiment. FIG. 2 is a diagram showing the construction of a microlens array, a support, and the like, where the liquid crystal display panel 10 is viewed from the backlight-incident side (lower side in FIG. 1).

As shown in FIGS. 1 and 2, the liquid crystal display panel 10 includes a composite substrate 12, a microlens array 14 composed of a plurality of microlenses 14a and disposed on the backlight-incident side of the composite substrate 12, a support 26 provided around the microlens array 14, an optical film 22 provided on the viewer's side (upper side in FIG. 1) of the composite substrate 12, and a protection layer 35 and an optical film 23 provided on the backlight-incident side of the microlens array 14. As viewed from the substrate plane normal direction, an outer face and an inner face of the support 26 extend in a rectangular shape parallel to the outer periphery of the composite substrate 12, the support 26 having corner portions (bent portions) which are bent about 90° at the four corners of the substrate.

The composite substrate 12 includes a TFT substrate 30 on which switching elements are formed for the respective pixels, a CF substrate (color filter substrate) 32 as a counter substrate, and a liquid crystal layer 34 interposed between the TFT substrate 30 and the CF substrate 32. The liquid crystal layer 34 is sealed by a sealing member 36 having a substantially rectangular planar shape, which is provided at the display outer periphery portion between the TIT substrate 30 and the CF substrate 32. A venthole (vent) 27 is provided in the support 26. The venthole 27 and its neighboring construction will be described in detail later.

The optical film 22 is attached to the composite substrate 12 via an adhesion layer 24, and an optical film 23 is attached to the protection layer 35 via an adhesion layer 37. Optical films 22 and 23 may include viewing angle compensation plates, phase difference plates, polarizing plates, or the like.

Each microlens 14a in the microlens array 14 is a lenticular-type lens in semicolumnar shape which covers a plurality of pixels. Note that each microlens 14a in the microlens array 14 may be formed as a hemispherical microlens corresponding to each pixel. Although the microlens array 14 is made of an acryl-type UV-curable resin which has a high transmittance for visible light, it may also be made of an epoxy-type UV-curable resin, a thermosetting resin, or the like.

The protection layer 35 and the microlens array 14 are formed in such a manner that the protection layer 35 is in contact with only the neighborhood of the apex of each microlens 14a, so that an internal space 17 which is surrounded by the support 26 is formed between the microlens array 14 and the protection layer 35. A construction may also be possible where the protection layer 35 is supported only by the support 26, such that the microlenses 14a are not in contact with the protection layer 35. A construction may also be possible where a projection is provided on the tip of each microlens 14a, such that the projection is in contact with the protection layer 35.

Similarly to the microlens array 14, the protection layer 35 is made of an acryl-type UV-curable resin having a high transmittance for visible light. However, an epoxy-type UV-curable resin or thermosetting resin may also be adopted for the protection layer 35. Preferably, the protection layer 35 is made of the same material as that of the microlenses 14a, or a material having a refractive index which is substantially equal to the refractive index of the material composing the microlenses 14a; however, they may be made of respectively different materials. Moreover, it is also preferable that the support 26 is made of the same material as that of the microlenses 14a, but may be made of a different material.

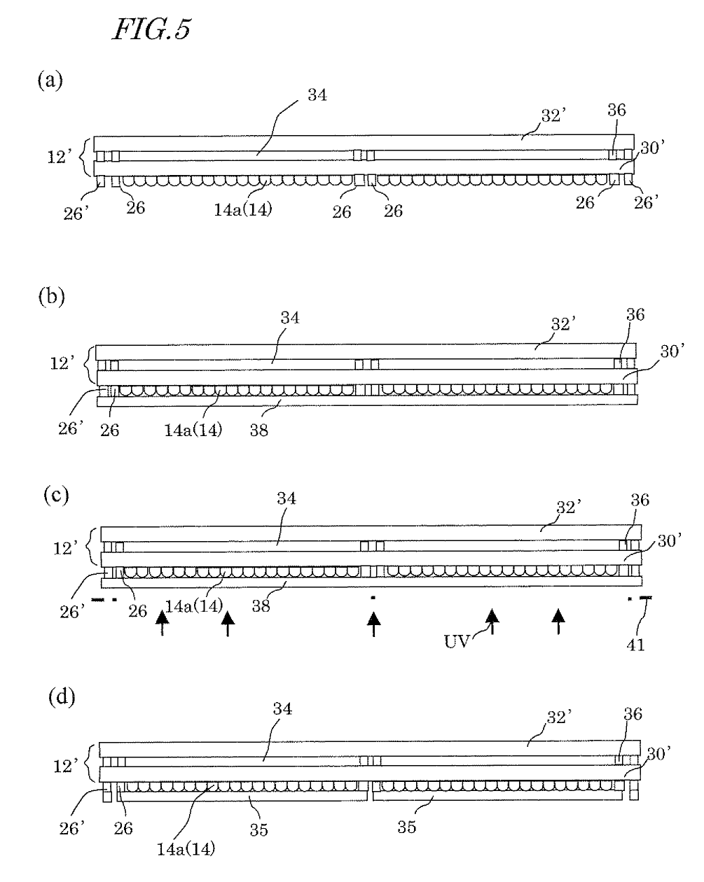

FIG. 3 is a diagram showing the construction of a corner portion (bent portion) S1 of the support 26 in FIG. 2 in more detail.

As shown in FIG. 3, the venthole 27 for connecting the internal space 17 and an external space 18 is formed in the support 26. The support 26 has a protrusion 26a which protrudes from an outer principal face 26b of the support 26 toward the external space 18, such that an opening 27a of the venthole 27 on the external space 18 side is formed within the protrusion 26a. The protrusion 26a and the venthole 27 extend so as to follow along a diagonal of the support 26.

The outer principal face 26b of the support 26 means a face which expands substantially in parallel to a direction that the support 26 extends, or a face which is formed substantially in parallel to a side face of the composite substrate 12 that is the closest to the principal face 26b.

The protrusion 26a has a cut facet 26c which is formed substantially in parallel to the principal face 26b of the support 26, or substantially in parallel to a side face of the composite substrate 12, such that the opening 27a of the venthole 27 is formed within the cut facet 26c. The cut facet 26c is a face which is created as the support 26 is cut by a cutter when cutting out the liquid crystal display panel from the mother substrate. The angle between the cut facet 26c and a side face 26d of the protrusion 26a is 90° or more. This angle is preferably greater than 90°, and is more preferably no less than 100° and no more than 160°.

In a corner portion S1 of the support 26, the support 26 is bent by about 90°, and the protrusion 26a protrudes from this bent portion toward the external space 18. The width of a cross section of the venthole 27 on a plane which is perpendicular to the direction that the venthole 27 extends is preferably no less than 50 μm and no more than 500 μm. Moreover, a venthole or ventholes similar to the venthole 27 may be formed in another corner portion or other corner portions of the support 26.

Next, a production method for the liquid crystal display panel 10 will be described with reference to FIGS. 4 to 7.

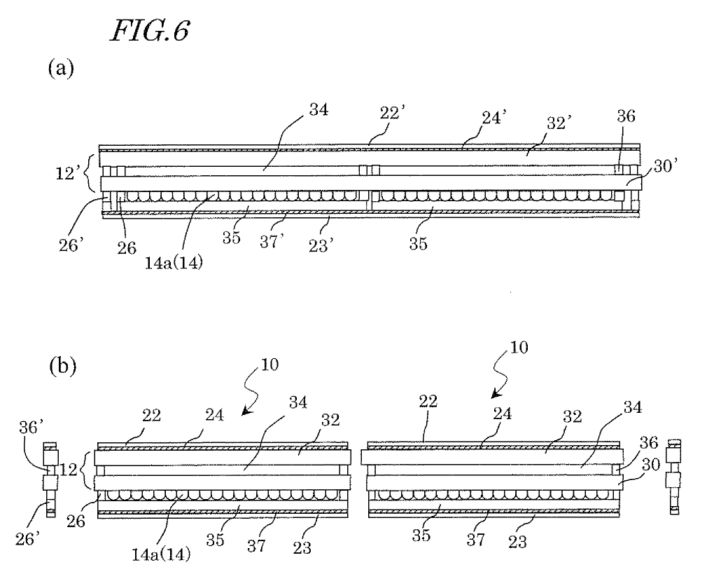

FIGS. 4(a) to (d), FIGS. 5(a) to (d), and FIGS. 6(a) and (b) are cross-sectional views schematically showing production steps of the liquid crystal display panel.

First, as shown in FIG. 4(a), a mother liquid crystal substrate (mother composite substrate) 12′ is provided, which is obtained by attaching a mother TFT substrate 30′ having switching elements formed for the respective pixels and a mother CF substrate 32′ as a counter substrate. Inside, the mother liquid crystal substrate 12′ includes a plurality of liquid crystal layers 34 in which liquid crystal is sealed by sealing members 36. The liquid crystal in the liquid crystal layers 34 is disposed by a liquid crystal dropping method. Furthermore, the composite mother liquid crystal substrate 12′ includes a dummy sealing member 36′ which is formed around the substrate so as to surround the plurality of liquid crystal layers 34 and the sealing members 36.

Next, as shown in FIG. 4(b), a large-sized dry film (resin layer) 39 composed of a UV-curable resin is attached on the backlight-incident side of the mother TFT substrate 30′.

Thereafter, as shown in FIG. 4(c), the dry film 39 is irradiated with UV light through the mother CF substrate 32′, whereby microlens arrays 14 are formed. Herein, formation of the microlens arrays 14 is performed by a self alignment method in which UV light is radiated while moving the composite mother liquid crystal substrate 12′ or a UV light source, thus to vary the incident angle of the irradiation light with respect to the liquid crystal panel stepwise or gradually. Since this self alignment method is a technique described in Patent Document 1, detailed descriptions thereof are omitted.

Next, as shown in FIG. 4(d), the dry film 39 is irradiated with UV light through a photomask 40, whereby supports 26 and dummy supports 26′ are formed. The microlenses 14a, the supports 26, and the dummy supports 26′ are formed all at the same height.

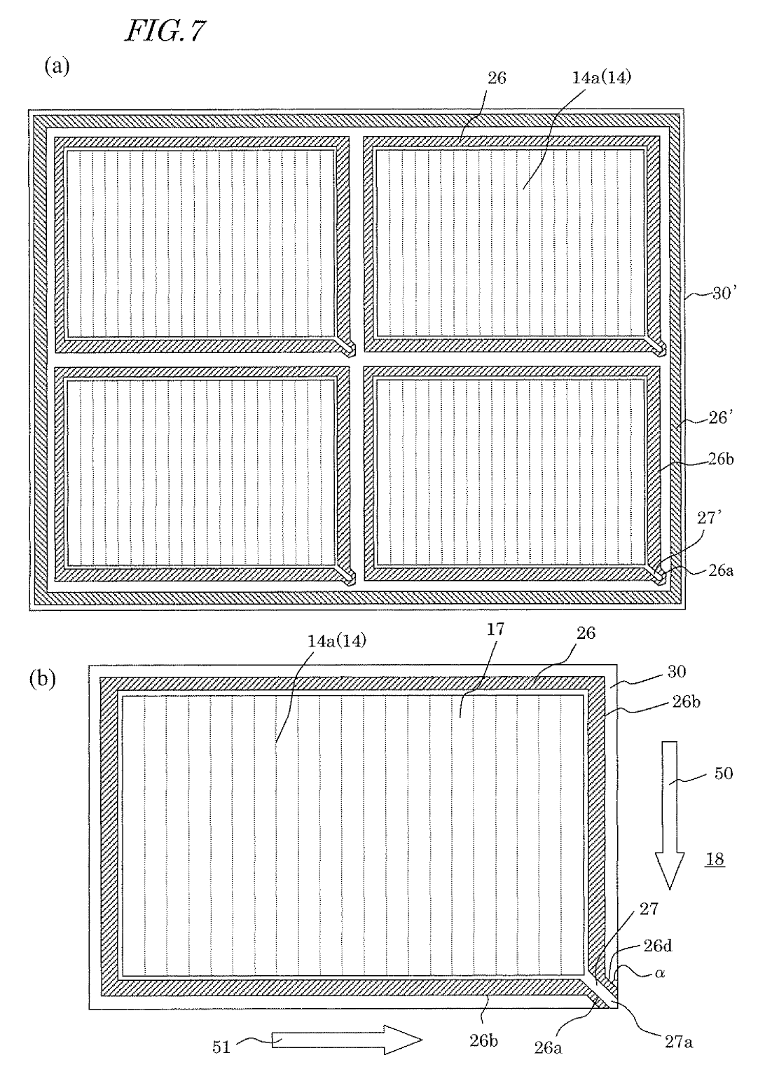

Thereafter, as shown in FIG. 5(a), the dry film 39 is subjected to a development treatment for removing any uncured dry film 39. At this time, as viewed from the substrate normal direction, a plurality of regions in which the frame-shaped supports 26 are formed are created on the mother liquid crystal substrate 12′, as will later be illustrated in FIG. 7(a). In each of the plurality of regions, the support 26 is formed so as to surround the microlens array 14. In a corner portion of the support 26 in each region, a protrusion which protrudes from the principal face 26b of the support 26 toward the outer side is formed, with a gap (internal groove) 27′ being formed in the protrusion. The gap 27′ is formed so as to have an opening only at the microlens array 14 side, and the outside edge of the gap 27′ is closed by the support 26. Therefore, at this point, the gap 27′ does not penetrate through the internal space and through the external space.

Next, as shown in FIG. 5(b), a dry film 38 composed of the same material as the dry film 39 is attached so as to be in contact with the microlens arrays 14, the supports 26, and the dummy support 26′. The dry film 38 is attached under a pressure of 0.05 to 1 MPa, in a temperature range from 50 degrees to the glass transition temperature. This attachment is carried out with a speed of 0.5 to 4 m/min.

Thereafter, as shown in FIG. 5(c), the dry film 38 is irradiated with UV light through the photomask 41, thereby selectively curing the dry film 38 over the apices of the microlenses 14a, the supports 26, and the dummy support 26′.

Next, the uncured dry film 38 is removed through a development treatment, thereby forming protection layers 35 as shown in FIG. 5(d). Herein, the protection layers 35 are fixed to the apices of the microlenses 14a and the supports 26.

Thereafter, as shown in FIG. 6(a), a large-sized optical film 23′ is attached to the protection layer 35 via an adhesion layer 37′, and a large-sized optical film 22′ is attached to the CF substrate 32′ via an adhesion layer 24′.

Finally, the substrate is severed by running a cutter (not shown) along lines for cutting the substrate, thus obtaining the plurality of liquid crystal display panels as shown in FIG. 6(b). A cutter for cutting optical films, a wheel cutter for forming a fissure in a glass substrate, or the like is used for severing the substrate. Since the details of the substrate severing method to be used herein are described in Patent Document 1 and the like, detailed descriptions thereof are omitted.

Next, with reference to FIG. 7, it will be described as to how the venthole 27 shown in FIG. 3 is formed.

In FIG. 7, (a) is a plan view showing the construction of the plurality of supports 26 and their neighborhood before the substrate is severed, and (b) is a plan view showing the construction of a support 26 and its neighborhood after severing.

As shown in FIG. 7, before the substrate is severed, each of the plurality of frame-shaped supports 26 has a protrusion 26a protruding from its corner portion toward the outside, with a gap 27′ being formed in the protrusion 26a. At this time, since the outer edge portion of the gap 27′ is closed by the material of the support 26, the gap 27′ does not penetrate through the internal space and through the external space.

Thereafter, by running a cutter in the direction of an arrow 50 in FIG. 7(b), the substrate is severed along the vertical direction, and at the same time, a right portion of the tip of the protrusion 26a is cut. Next, by running a cutter in the direction of an arrow 51, the substrate is severed along the horizontal direction, and at the same time, a lower portion of the tip of the protrusion 26a is cut. As a result of cutting the tip of the protrusion 26a in this manner, an opening 27a connecting the gap 27′ with the external space 18 is formed in the protrusion 26a, such that the remaining gap 27′ becomes a venthole 27 connecting the internal space 17 and the external space 18.

According to the above-described production method of the liquid crystal display panel 10, the venthole 27 is formed by, after forming the protection layer 35, cutting a portion of the protrusion 26a provided outside the gap 27′. Therefore, in the step of producing the protection layer 35, the developer and the uncured UV-curable resin are prevented from intruding into the internal space 17.

Moreover, when severing the substrate, the cutter will cut into the side face 26d of the protrusion 26a at an acute angle α of approach. Therefore, the impact and stress which the protrusion 26a receives when the tip of the protrusion 26a is cut is reduced, and thus occurrence of cracks in the protrusion 26a or the support 26 can be reduced. The angle of approach of the cutter with respect to the side face 26d may be 90° or less, but is preferably less than 90°, and more preferably no less than 20° and no more than 80°. As a result of thus cutting the tip of the protrusion 26a, as shown in FIG. 3, the angle between the cut facet 26c and the side face 26d of the protrusion 26a is 90° or more. This angle is preferably larger than 90°, and more preferably no less than 100° and no more than 160°.

Next, a first variant of the above embodiment will be described. The liquid crystal display panel according to the first variant differs from the above-described embodiment only with respect to the neighboring construction of the venthole 27, while the construction of the other portions is the same. Therefore, the following descriptions will be mainly directed to differing portions, and the description of any identical portion will be omitted.

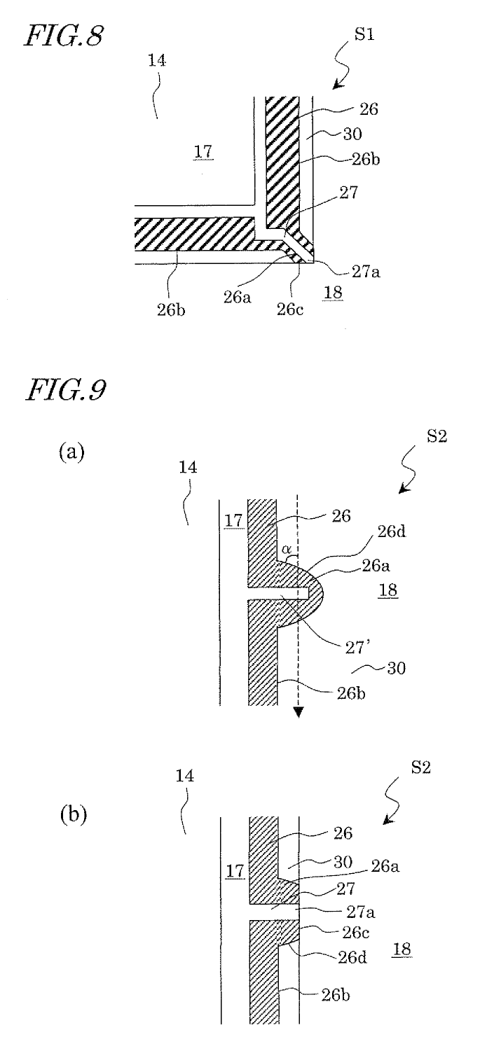

FIG. 8 is a diagram showing the construction of a corner portion S1 of the support 26 according to the first variant. This corner portion corresponds to the corner portion S1 in FIG. 2.

As shown in FIG. 8, similarly to the above-described embodiment, the support 26 according to the first variant includes a protrusion 26a which protrudes from the outer principal face 26b of the support 26 toward the external space 18. However, the venthole 27 which is formed in the corner portion and in the protrusion 26a of the support 26 so as to connect the internal space 17 and the external space 18 does not extend in a linear shape, but is formed in a bent shape or a crank shape.

The opening 27a of the venthole 27 is formed by a method similar to the above-described production method. Specifically, in the corner portion S1 before cutting the substrate, a gap 27′ is formed which is closed at the outer face, an as the tip of the protrusion 26a is cut upon severing of the substrate, the venthole 27 having the opening 27a is formed.

According to the first variant, the following advantages are obtained in addition to the advantages obtained in the above-described embodiment. Firstly, since the venthole extends while bending, air or the like will not suddenly flow into the internal space through the venthole 27. Therefore, dew condensation and mixing of foreign matter or the like during production or use of the liquid crystal display device are prevented, whereby display unevenness is suppressed. Moreover, since a portion with weak attachment strength does not concentrate in a portion of the support, distortion, warp, deformation, peeling, and the like of the optical films are also prevented.

Note that, although the venthole 27 according to the first variant has two bent portions which are respectively bent by about 90° and about 45°, the bent portions may be bent at any other angles, and one bent portion or three or more bent portions may be provided in the venthole 27. Moreover, instead of a bent portion, a curved portion having a gentle curve may be provided.

Next, a second variant of the above embodiment will be described. The liquid crystal display panel according to the second variant differs from the above-described embodiment only with respect to the position and construction of the venthole 27, while the construction of the other portions is the same. Therefore, the following descriptions will be mainly directed to differing portions, and the description of any identical portion will be omitted.

FIG. 9 is a diagram showing the construction of an edge portion (corresponding to an edge portion S2 in FIG. 2) of the support 26 according to the second variant, where: (a) shows the construction of the edge portion before the substrate is severed; and (b) shows the construction of the edge portion after the substrate is severed.

In the corner portion S1 of the second variant, the protrusion 26a, the venthole 27, and the gap 27′ as have been described in the embodiment or the first variant are not formed. Instead, a protrusion 26a, a venthole 27, and a gap 27′ as described below are formed. Note that, together with the below-described construction of the edge portion S2, the structure of the corner portion S1 according to the embodiment or the first variant may also be applied to the second variant.

As shown in FIG. 9(a), the support 26 according to the second variant before severing has a protrusion 26a which protrudes from the outer principal face 26b of the support 26 toward the external space 18 at the position of the edge portion S2. The protrusion 26a is formed so as to gently rise from the principal face 26b of the support 26.

In the support 26, a gap 27′ which extends from its opening on the internal space 17 side into the protrusion 26a is formed. Although the gap 27′ herein extends perpendicularly to the inner face of the support 26, the gap 27′ may be formed with a tilt against the inner face of the support 26. The gap 27′ is covered by the material of the support 26 at its edge portion on the external space 18 side, and therefore is not in communication with the external space 18.

In the step of severing the substrate, the protrusion 26a having such a construction is cut by a cutter in the direction shown by a dotted-line arrow. As shown in FIG. 9(b), an opening 27a is formed in the protrusion 26a having been cut, whereby the venthole 27 connecting the internal space 17 and the external space 18 is formed.

As in the above-described embodiment, the venthole 27 according to the second variant is formed by cutting the protrusion 26a after the protection layer 35 is formed. Therefore, in the step of producing the protection layer 35, the developer and the uncured UV-curable resin are prevented from intruding into the internal space 17.

Moreover, the cutter will cut into the side face 26d of the protrusion 26a at an acute angle α of approach also in the substrate severing step according to the second variant, so that the impact and stress received by the protrusion 26a when the tip of the protrusion 26a is cut are reduced, whereby occurrence of cracks in the protrusion 26a or the support 26 can be reduced. Since the protrusion 26a is cut in this manner, the angle between the cut facet 26c and the side face 26d of the protrusion 26a is greater than 90°.

Next, a third variant of the embodiment will be described. The liquid crystal display panel according to the third variant differs from the second variant only with respect to the shapes of the protrusion 26a, the venthole 27, and the gap 27′, while the construction of the other portions is the same. Therefore, the following descriptions will be mainly directed to differing portions, and the description of any identical portion will be omitted.

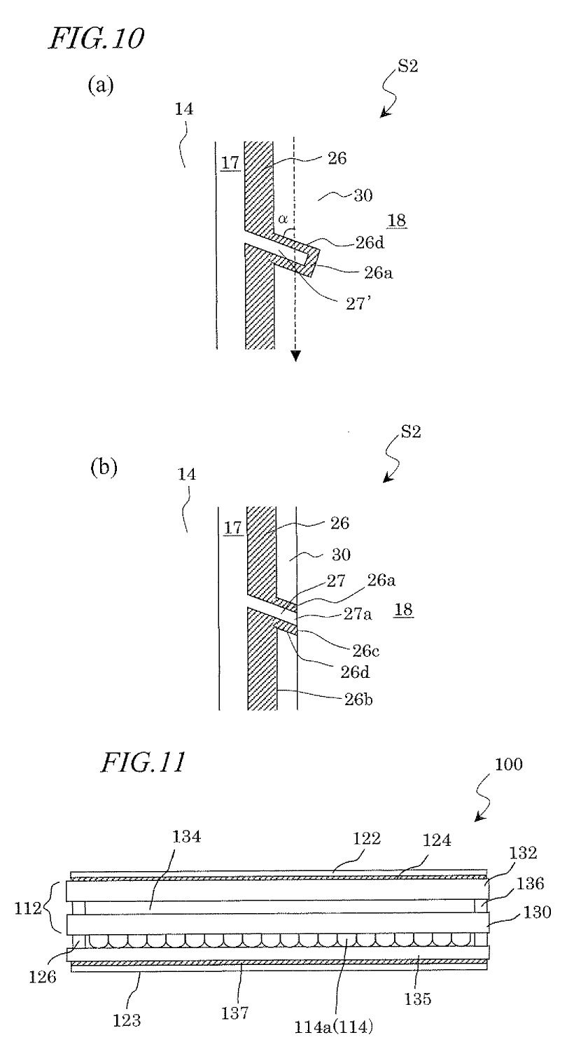

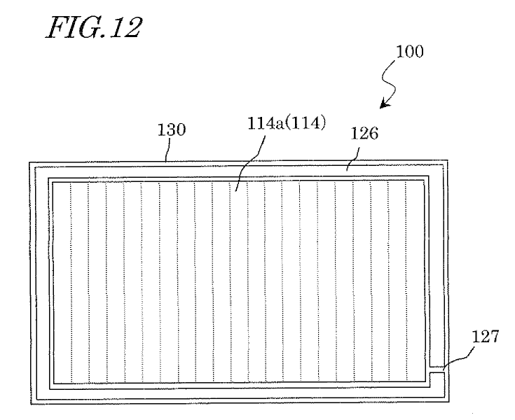

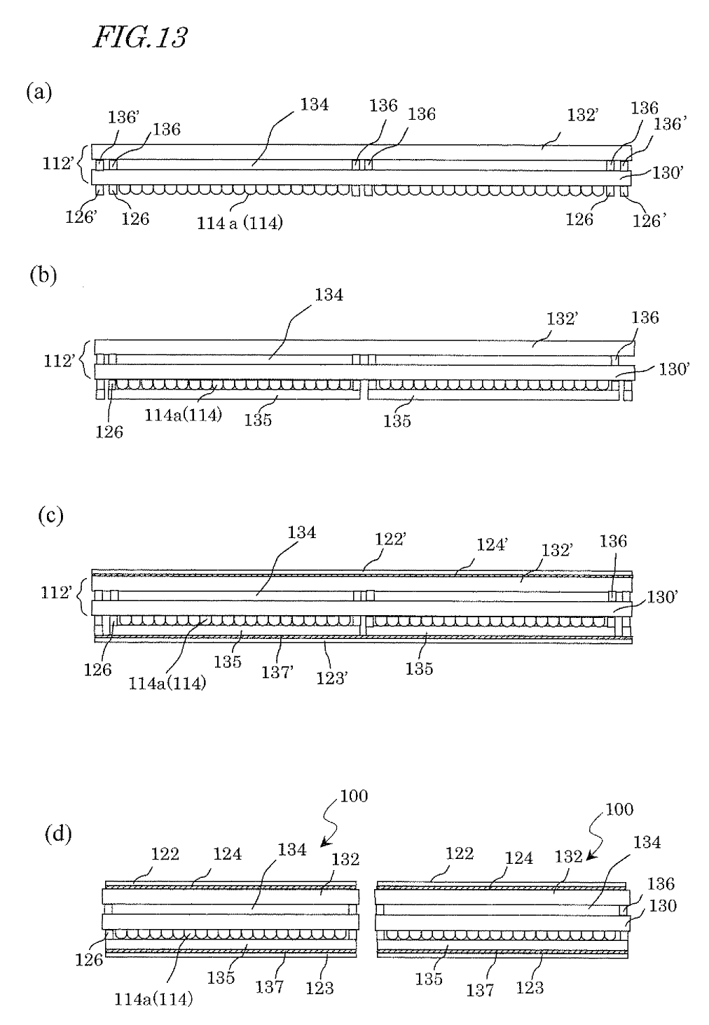

FIG. 10 is a diagram showing the construction of an edge portion (corresponding to the edge portion S2 in FIG. 2) of the support 26 according to the third variant, where: (a) shows the construction of the edge portion before the substrate is severed; and (b) shows the construction of the edge portion after the substrate is severed.

As shown in FIG. 10(a), the support 26 according to the third variant before severing has a protrusion 26a which protrudes from the outer principal face 26b of the support 26 toward the external space 18 at the position of the edge portion S2. The protrusion 26a is formed so as to protrude in a cylindrical shape from the principal face 26b of the support 26 in an oblique direction.

In the support 26, a gap 27′ which extends from its opening on the internal space 17 side into the protrusion 26a is formed. Similarly to the protrusion 26a, the gap 27′ also extends in an oblique direction with respect to the principal face 26b. The gap 27′ is covered by the material of the support 26 at its edge portion on the external space 18 side, and therefore is not in communication with the external space 18.

In the step of severing the substrate, the protrusion 26a having such a construction is cut by a cutter in the direction shown by a dotted-line arrow. As shown in FIG. 10(b), an opening 27a is formed in the protrusion 26a having been cut, whereby the venthole 27 connecting the internal space 17 and the external space 18 is formed.

Similarly to the second variant described above, the venthole 27 according to the third variant is formed by cutting the protrusion 26a after the protection layer 35 is formed. Therefore, in the step of producing the protection layer 35, the developer and the uncured UV-curable resin are prevented from intruding into the internal space 17.

Moreover, the cutter will cut into the side face 26d of the protrusion 26a at an acute angle α of approach also in the substrate severing step according to the third variant, so that the impact and stress received by the protrusion 26a when the tip of the protrusion 26a is cut is reduced, whereby occurrence of cracks in the protrusion 26a or the support 26 can be reduced. Since the protrusion 26a is cut in this manner, the angle between the cut facet 26c and the side face 26d of the protrusion 26a is greater than 90°.

Although the gap 27′ and the venthole 27 extend in a linear shape in the above-described second variant and third variant, they may be formed in a bent or crank shape. Although the gap 27′ and the venthole 27 are illustrated as being formed only at the edge portion S2 of the support 26, they may be formed in plurality at edge portions or corner portions of the support 26. Moreover, the gap 27′ and the venthole 27 described in the embodiment and the first to third variants may be used in combination within a single liquid crystal display panel.

In the above-described embodiment and variants, when severing the mother liquid crystal substrate 12′, the protrusion 26a of the support 26 is cut at the same time the optical film 23′ is cut. However, the cutting of the optical film 23′ and the cutting of the protrusion 26a may be carried out in separate steps. Moreover, it has been illustrated that, after liquid crystal injection, large-sized optical films are attached, and then the mother liquid crystal substrate 12′ is severed. However, after severing the mother liquid crystal substrate 12′, liquid crystal may be injected, and then the microlens array 14, the support 26, and the protection layer 35 may be formed, and then finally the optical film 23 may be attached.

### INDUSTRIAL APPLICABILITY

According to the present invention, the display quality and reliability of a liquid crystal display panel having a relatively small aperture ratio, e.g., a transflective type liquid crystal display panel, are improved.

1. A production method for a liquid crystal display panel having: a composite substrate including a liquid crystal layer disposed between a pair of substrates; a microlens array provided on a light-incident side of the composite substrate; and an optical film provided on a light-incident side of the microlens array, with an internal space being formed between the microlens array and the optical film, the production method for a liquid crystal display panel comprising the steps of:
(a) forming a resin layer on a face of a mother liquid crystal substrate, the mother liquid crystal substrate including a plurality of said composite substrates;
(b) processing the resin layer to form a plurality of microlens arrays and a plurality of supports respectively surrounding the plurality of microlens arrays; and
(c) cutting the mother liquid crystal substrate to obtain a plurality of liquid crystal display panels, wherein, at step (b), a gap which is connected to the internal space is fowled in each of the plurality of supports; and
at step (c), upon cutting of the mother liquid crystal substrate, an opening connecting the gap and an external space is formed in an outer face of each of the plurality of supports.

2. The production method of claim 1, wherein, at step (b), a protrusion protruding from the outer principal face toward the external space is formed on each support, a portion of the gap being formed in the protrusion.

3. The production method of claim 2, wherein, at step (c), the opening connecting the gap and the external space is formed when the protrusion is cut upon cutting of the mother liquid crystal substrate.

4. The production method of claim 3, wherein, at step (c), the mother liquid crystal substrate and the protrusion are cut by a cutter, and an angle of approach of the cutter with respect to a side face of the protrusion is less than 90°.

5. The production method of claim 4, wherein, at step (c), an angle of approach of the cutter with respect to the side face of the protrusion is no less than 20° and no more than 80°.

6. The production method of claim 2 wherein, at step (b), a bent portion which is bent by about 90° as viewed from a direction normal to a plane of the composite substrate is formed on the support, and the protrusion is formed so as to protrude from the bent portion.

7. The production method of claim 1, wherein, at step (b), the gap is formed so as to extend in an oblique direction with respect to an inner face or the outer face of the support as viewed from a direction normal to a plane of the composite substrate.

8. The production method of claim 1, wherein, at step (b), the gap is formed in the support so as to extend while bending as viewed from a direction normal to a plane of the composite substrate.

9. A liquid crystal display panel comprising:
a composite substrate including a pair of substrates and a liquid crystal layer disposed between the pair of substrates;
a microlens array provided on a light-incident side of the composite substrate;
a support provided on the light-incident side of the composite substrate so as to surround the microlens array; and
an optical film attached to the composite substrate via the support, wherein, the support has a protrusion protruding from an outer principal face of the support toward an external space;
a venthole is formed in the support, the venthole connecting an internal space surrounded by the support and an external space; and
an opening of the venthole on the external space side is formed in the protrusion.

10. The liquid crystal display panel of claim 9, wherein the principal face of the support is a face which is formed substantially in parallel to a direction that the support extends, or substantially in parallel to one of side faces of the composite substrate.

11. The liquid crystal display panel of claim 9, wherein the protrusion has a cut facet which is formed substantially in parallel to the principal face of the support, or substantially in parallel to one of side faces of the composite substrate, and the opening of the venthole is formed in the cut facet.

12. The liquid crystal display panel of claim 11, wherein an angle between the cut facet and a side face of the protrusion is greater than 90°.

13. The liquid crystal display panel of claim 12, wherein the angle between the cut facet and the side face of the protrusion is no less than 100° and no more than 160°.

14. The liquid crystal display panel of claim 9, wherein the support has a bent portion which is bent by about 90° as viewed from a plane normal direction of the composite substrate, and the protrusion protrudes from the bent portion toward the external space.

15. The liquid crystal display panel of claim 9, wherein the venthole extends in an oblique direction with respect to an inner face or an outer face of the support as viewed from a plane normal direction of the composite substrate.

16. The liquid crystal display panel of claim 9, wherein the venthole extends while bending as viewed from a plane normal direction of the composite substrate.

17. The liquid crystal display panel of claim 9, wherein a cross section of the venthole on a plane which is perpendicular to a direction that the venthole extends has a width of no less than 50 μm and no more than 500 μm.

18. The liquid crystal display panel of claim 9, wherein a plurality of said ventholes are formed in different portions of the support.
